(19) United States
(12) Patent Application Publication
(10) Pub. No.: US 2019/0080391 A1
(43) Pub. Date: Mar. 14, 2019

(54) Mobile application providing a grocery shopping system

(71) Applicant: Ernest McNair, Spring Valley, CA (US)

(72) Inventor: Ernest McNair, Spring Valley, CA (US)

(21) Appl. No.: 16/120,391

(22) Filed: Sep. 3, 2018

Related U.S. Application Data
(60) Provisional application No. 62/557,050, filed on Sep. 11, 2017.

(51) Int. Cl. G06Q 30/06; G06F 17/30

(52) U.S. Cl. CPC G06Q 30/0643; G06F 17/30994

(57) ABSTRACT

The invention is directed to a mobile application providing a grocery shopping system. The system provides a mobile application which may be downloaded and installed on a smartphone, laptop, tablet, or other personal electronic device. The application displays a set of virtual shelves which are empty when the application is opened. The system further provides an administrative database which stores and retrieves inventory information, which may inform the user regarding all the available grocery items for purchase. The user is prompted to select a category of items to browse, such as fresh meat, fresh produce, canned goods, or bakery goods. The database then displays easily identified visual icons representing the available items in the selected category. The user may click on selected items and drag them to the shelves, signaling the website that the user wishes to purchase the selected items and have them delivered.

### SPECIFICATION

This application relates back to, and claims the priority of Provisional Patent Application No. 62/557,050 filed on Sep. 11, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to mobile applications and in particular to a mobile application providing a grocery shopping system. Online shopping services have become fairly well known, but the weaknesses are perhaps not so well known. Individuals who may live a substantial distance from a traditional bricks-and-mortar store are often delivered the wrong items, and the problem of returning such items and replacing them with the correct items can be difficult to overcome in the case of perishable items, such as groceries. Even being able to speak with a human being online to correct the problem usually entails a substantial investment of time. Simply trying to communicate with an online representative to correct such problems might be a built-in obstacle due to language barriers.

A search of the prior art reveals various devices which have been developed to address this set of problems, or related problems. None are closely related to the present invention, but several include features which resemble those of the present invention. Each has proven to be less than satisfactory for the present purpose in its own way.

List-based selection system and methods for using same, U.S. Pat. No. 7,424,447 (priority Aug. 26, 2002), provides a system and methods for enabling a user to create a list of items on a portable computing device, to communicate with external devices to locate each of the items available on the list within a geographically limited area, to provide users with visual or aural cues as to the location of items on the list, to progress through the list of items as each item is selected or rejected, and providing discounts toward, information about, or alternatives to the available items on the list.

Methods and systems for receipt management and price comparison, U.S. Pat. No. 7,792,709 (priority Oct. 8, 2008), provides methods and systems for maintaining purchase records, creating shopping lists, and comparing merchant pricing. The user experience in performing shopping functions is simplified and enhanced over existing methods. Example embodiments listed create a more convenient, reliable, complete, and secure record keeping process for purchased items. In addition, embodiments of the present invention provide methods and systems to enable a service provider to offer price comparison services (or shopping assistance) that include searching, organizing, and storing purchase records and to assist consumer purchase decisions. In addition, internal and external databases/data stores are queried to link or further enhance the data/objects organized and stored related to consumer purchases. In addition, certain methods and systems described herein facilitate the creation of shopping lists which optionally include local price comparisons. In addition, certain methods and system described herein provide price alert notification services related to items typically purchased by a consumer.

Enhanced mobile application for assisting users at a point of transaction, U.S. Patent Appl. No. 2013/0191232A1 (priority Jan. 23, 2012), provides systems, methods, and computer-program products that provide for an enhanced mobile application for assisting users at a point-of-transaction (POT). In one embodiment of the invention the POT assistance application program may determines that a user is conducting a transaction with a merchant. The user may utilize a user device to assist in the transaction. First, the user device may be paired with a POT system, such as a cash register. Once the devices are paired a communication link is created that allows the user to audibly and/or visually monitor the transaction using the user device. Furthermore, the user may flag an item for review during the transaction, silence the transaction, receive a subtotal for the transaction, select a payment method, or complete the transaction using the POT assistance application program.

Systems and method for configuring mobile device applications based on location, U.S. Patent Appl. No. 2014/0066101A1 (priority Aug. 30, 2012), provides methods and systems for automatically configuring mobile device applications based on location are described. In an example, methods and systems for enabling contextual in-store experience modification on a mobile device can include capabilities for altering the functionality of a mobile application based at least in part on the location of the mobile device. For example, a mobile shopping application can be configured to perform different functions depending upon the type of retail location the mobile device is currently in. Additionally, the mobile application can be configured to enable different functions between a retail location and a user's residence, among other locations.

Grocery recommendation engine, U.S. Patent Application No. 2014/0074649A1 (priority Sep. 13, 2012), provides a method which comprises detecting a user state, from a plurality of different enumerated user states, based on items that the user recently selected, and/or location data. Based upon the detected user state, a particular algorithm, from a plurality of algorithms, is selected for recommending items. Information about the recommended items is presented to the user. Responsive to presenting the information about the recommended items, input is received selecting one or more of the recommended items for at least one of: adding to a shopping list, or requesting a coupon. Examples of possible detected user states include a recipe state, a grocery shopping state, and a quick shopping-run state. In an embodiment, state detection occurs at a client device, such as a smartphone featuring a shopping list management application or coupon application. A server-side recommendation engine provides recommendations.

Shopping list system and process, U.S. Patent Application No. 2013/0046648A1 (priority Aug. 17, 2011), provides a system which enables a user to create a virtual shopping list that is used to identify offers for products in which the user is interested. The shopping list may be one single list or may be broken down into categories, in order to group like products together or group products together that can be purchased at one or more locations near each other. The shopping list may be transmitted to one or more businesses, such that the businesses may submit bid requests, in a reverse bid auction, for the one or more products on the shopping list. The best bids of the one or more businesses may be returned to the user. The bids may be identified as the best bids based on the lowest prices for the product, the best quality products, the proper quantities of the products, the locations at which the products are located, etc.

Retail store product location service system and method, U.S. Patent Appl. No. 2009/0012704A1 (priority Jul. 2, 2007), provides a product location system comprising an interface to a network accessible by a user equipment and configured to receive a user request for location of at least one product and a store/product location system comprising a database identifying stores and product locations within the stores and configured to return a product location within a store for each of the at least one product.

If an online grocery shopping system could be developed with the capability of helping shoppers to identify desired items for purchase in a completely foolproof manner, it would be very useful, and would be well received. Such a system would be particularly useful for shoppers who are not able to shop by conventional means due to time, travel restrictions, availability or accessibility. A mobile application providing a grocery shopping system, which provides clearly identifiable visual icons for the shopper to select and place on a virtual shelf for purchase and delivery, would resolve these problems.

### SUMMARY OF THE INVENTION

Accordingly, the invention is directed to a mobile application providing a grocery shopping system. The system provides a mobile application which may be downloaded and installed on a smartphone, laptop, tablet, or other personal electronic device. The application displays a set of virtual shelves which are empty when the application is opened. The system further provides an administrative database which stores and retrieves inventory information, which may inform the user regarding all the available grocery items for purchase. The user is prompted to select a category of items to browse, such as fresh meat, fresh produce, canned goods, or bakery goods. The administrative database then displays easily identified visual icons representing the available items in the selected category. The user may click on selected items and drag them to the shelves, signaling the website that the user wishes to purchase the selected items and have them delivered.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

No drawing is provided for the disclosed invention, because a drawing is not necessary for the understanding of the invention under 35 U.S.C. § 113, 37 C.F.R. § 1.81(a), and MPEP § 608.02 (III) (B).

### DETAILED DESCRIPTION OF THE INVENTION

Referring now to the invention in more detail, the invention is directed to a mobile application providing a grocery shopping system.

The first exemplary embodiment is comprised of a system providing a mobile application, which may be downloaded and installed on a smartphone, laptop, tablet, or other personal electronic device. The application displays a set of virtual shelves, illustrated in the form of a pantry or cupboards and an open refrigerator, which are empty when the application is opened.

The system further provides an administrative database which stores and retrieves inventory information, which may inform the user regarding all the available grocery items for purchase. The user is prompted to select a category of items to browse, such as fresh meat, fresh produce, canned goods, or bakery goods. The administrative database then displays easily identified visual icons representing the available items in the selected category. Once selected by the user, an icon is caused to appear on one of the virtual shelves in the cupboard or refrigerator displayed by the application.

The system further provides a search engine, optimized to search for recipes for a dish selected by the user, then populate a shopping list, and shop for all of the items which are required to prepare the recipe, or a portion thereof as selected by the user. The application operates the search engine and indexes the search results.

The system may optionally inform the user regarding the quantity of each grocery item in stock and available for purchase, using information from one or more inventory files. The action required to learn the number of available items which are represented by each icon may be causing the cursor to hover over the icon without clicking on it, or the action required may be some other action. When an order of one or more items has been completed by the user, the user may pay electronically for the order. The order may be delivered by employees of the system, or picked up by the user.

To use the first exemplary embodiment, the user may first elect to use the search engine to select desired items for the shopping list. The user may then generate the shopping list, click on selected items, and drag them to the shelves, signaling the website that the user wishes to purchase the selected items and have them delivered. Alternately, upon selecting items for purchase, the user may click on the desired icon for a specific product to add to a list which can be saved or archived for future access and shopping purposes. Each selected icon traverses the user's visual display from shelf to pantry, by passing a shopping cart icon, and is placed on a pantry, cupboard, or refrigerator shelf upon purchase. Payment may be made by credit card, debit card, or PayPal™.

The mobile application provides a way to track, organize, and manage the food and kitchen items in the household, as well as facilitate easy grocery shopping. It will keep an inventory of items, as well as the quantity of each item, and use an intuitive and appealing app graphic design, with custom icons and quick navigation.

The user will manage the pantry item types and the quantities via the application. They can add items from a pre-populated database, or they can add their own. Items will have a preset measurement value that can be tracked by the user. And when that quantity is nearly depleted, the user will get a notification to buy that item the next time the user goes grocery shopping. Those items will automatically appear in their “Grocery List” to use while they are at the store. The user can also add items manually from their current pantry inventory, or brand new items from the database. In addition, they can save a grocery list to use it again in the future. The grocery list will be sorted and categorized for easy shopping, and provide a method to “check off” items from the list as the user shops. The database of the standard grocery and kitchen items will be managed by the app Administrator, and be pre-loaded prior to app release. The database will contain potentially hundreds of items, and will be quantified by the user as a fraction of the total (in other words, an item could be ¾ full, etc.).

The Administrator can add or delete items at any time. In the future, the application will incorporate recipes that can be searched and browsed. Selecting a recipe can tailor the grocery list as well as the pantry quantities.

The application's opening screen will display a brief splash screen, then a login screen with an account creation screen for first time users. The application displays the openings screen the first time the application is opened, or after a user logs out (otherwise, this screen is bypassed).

If creating a new account, the user is asked to create a username, with the option of using an email address as the username, and a password. The application requires an accept button for the Privacy Policy. Otherwise, the login screen automatically bypasses, unless the user chooses to log out via the Settings screen. (If so, then login screen will have input for username and password, as well as “Forgot Password” option)

Next the application offers a very short demonstration screen, or sequence of up to three screens, for first-time users, highlighting the features, navigation, and commands such as the “Next” button, “Back” button, and “Skip.”

For navigation of the application a navigation menu is provided at the bottom of the screen, with only two options: My Pantry and Grocery List. In a future version, there may be more navigation options such as recipes. A Settings icon is provided in the upper right corner of the screen, which will also contain Profile options.

My Pantry is the “home screen”, and will show a list of everything in the user's pantry inventory. The default view is a grouped list sorted by “Grocery Aisle.” Each Grocery Aisle will be defined by the Administrator within the database. Each aisle will have its own custom icon image, also uploaded by the Administrator. The list will have a small thumbnail image, the name of the item, and the quantity of that item. The user may scroll up and down through all items, and tap to edit. An edit opens new full screen, superimposed on pantry screen with a smaller window, and shows the icon image of the item. An

Interactive section is provided to change quantity. Possible values to select are 100%, 75%, 50%, 25%, and 0%. There can also be an option for “×2” if the user has more than one of the same item.

The My Pantry screen further provides Save/Cancel buttons, enabling the user to rearrange items or recategorize items, and a checkbox to indicate the user wants to add that item to the grocery list. (See Grocery List section below for details). The user may swipe left to delete with a popup to confirm delete, and a Search feature within the title bar. The My Pantry screen further provides auto-populate function, a sort feature, and a search function. The search can be done by item or by aisle. The default is by “Grocery Aisle” which will be defined in the database. Other sort options are available by quantity and alphabetically, “recently viewed” or “recent grocery list” data points to be tracked by the application.

An Add button is provided at the top of the screen, which opens a new screen. The user is offered a choice of search methods to add an item to My Pantry. The user can browse all items within an “Aisle” and can also sort within an aisle, or auto-fill the item name while typing. Tapping the “Add” button will add this item into My Pantry. Tapping the “Cancel” button will return the user to the My Pantry screen.

An additional button will be provided for an “Add Custom Item.” This is for any item which is not in the master database. The user can type in any item name desired, and adjust the quantity. No picture will be available; the application will just use a generic icon. The user must assign the “Aisle.” At this time user-added items will not be added to the master database but that feature may be added in the future.

The My Pantry screen will also provide a “Generate Grocery List from checked items” button. This automatically adds items to a new grocery list. This function will also be available within the Grocery List screens. Any pantry item that is 25% or 0% full, will generate a notification to the user offering the option to add that item to the grocery list. The user can “Add All”, or select items one by one to be added.

A Grocery List screen is further provided, with the same layout style as the My Pantry list. each item is represented by an item icon, and item name, grouped by Aisle. The items are also sortable and searchable. As items are checked off, the user can also sort by purchased item. Tapping an item will show its current pantry quantity. Purchasing the item automatically increments that quantity in the user's Pantry inventory. The user may swipe left to delete with confirmation popup.

An Add button is provided, to add a new item to grocery list. Tapping the Add button results in a popup which will ask whether to search the current Pantry or add a new Item from the database, or add a new custom item. Standard search features are available, with auto-populate. The user may tap to select, which automatically adds the item to the Pantry list.

The application further provides a Functions button. Note that at this time there will only be one active Grocery List, and the user will not be able to view past lists, nor maintain multiple lists. The Functions button may be used to start a new, empty Grocery List, and add checked items from the Pantry to the Grocery List, or copy the last Grocery List, essentially taking the current list and “unchecking” all of the items. The Functions button may then be used to merge the last Grocery List into the newest list, essentially adding all Pantry checked items and adds them to prior Grocery List, without duplicating.

The user can tap a checkbox to indicate in real-time when an item has been purchased, or put into the shopping cart. This is intended to be done while actually shopping, and may possibly show a strikethrough line on that item as if it were crossed out from a list. Though the list can be sorted in many ways, the default should always be by “aisle” to make it as easy and quick as possible for the user. If the user leaves the Grocery List screen and has checked any button, the application will ask if the user wants to increment that pantry amount (since it assumes the user was shopping, then purchased one or more items, and is now returning to the Pantry screen)

The Settings screen provides a username/profile reset, logout, the Privacy Policy, the Terms and Conditions, and possibly more functions in the future. The Administrative Panel provides an Admin login for a private website not accessible by most users. The website provides basic Admin functions, such as a display of standard statistics for users and sessions, the management of users to sort, delete, and edit, and the ability to edit Terms and Conditions and the Privacy Policy.

The Database Admin functions include containing every pantry item available, with the basic fields of a thumbnail photo, name, aisle, and quantity-type. The database needs to be scalable to add potential fields in the future. The initial database will be more than 2000 records. New records will be frequently added on an ongoing basis by the Administrator, and will need to be continually available to users in their searches. For example, the Administrator could maintain an Excel spreadsheet of items, and then could import to the Admin Panel with new changes. This could also possibly be a txt/cvs format file or an Access database. Then these changes will be automatically reflected within the application. The Admin can sort by any column and search, and edit. A potential future feature of the user's ability to add pantry items that would be available to all users.

The monetization of the application is to be determined. It will likely be a paid store application for a price such as $1.99, possibly with a free trial period. Ad-supported or “freemium” is possible, perhaps with also unlocking premium features. The monetization could leverage the “game”/points feature described below, whereby the user is required to gain frequent session points to keep the application free. A subscription strategy is possible, but unlikely.

Client responsibilities include choosing a domain name from GoDaddy or a similar provider, enroll with Apple or Google as a Developer for $99 per year, and setup a server account with Amazon Web Services which is free for the first year, then approximately $15 per month.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A mobile application providing a grocery shopping system, comprised of a mobile application, which may be downloaded and installed on a smartphone, laptop, tablet, or other personal electronic device, which displays a set of virtual shelves, illustrated in the form of a pantry or cupboards and an open refrigerator, which are empty when the application is opened.
